(19) United States
(12) Patent Application Publication
(10) Pub. No.: US 2008/0302713 A1
(43) Pub. Date: Dec. 11, 2008

(54) ANTIMICROBIAL FILTER CARTRIDGE

(76) Inventor: Gilbert Patrick, Kings Mountain, NC (US)

Correspondence Address: WOMBLE CARLYLE SANDRIDGE & RICE, PLLC, ATTN: PATENT DOCKETING 32ND FLOOR, P.O. BOX 7037, ATLANTA, GA, 30357-0037, US

(21) Appl. No.: 12/132,732

(22) Filed: Jun. 4, 2008

Related U.S. Application Data
(60) Provisional application No. 60/942,046, filed on Jun. 5, 2007.

(51) Int. Cl. B01D 39/04

(52) U.S. Cl. 210/234; 210/266; 210/321.72

(57) ABSTRACT

An antimicrobial filter cartridge having a microporous core member about which is applied a yam which may be impregnated with a antimicrobial agent. The filter cartridge is sized so as to fit tightly into a cartridge housing of a fluid filtration system. Fluid passing through the cartridge housing will be filtered by the filter cartridge to remove bacteria and other contaminants from the water and which prevents the growth of bacterial and other microorganisms on the filter media.

### CROSS REFERENCE TO RELATED APPLICATIONS

The present Patent Application is a formalization of previously filed, co-pending U.S. Provisional Patent Application Ser. No. 60/942,046, filed Jun. 5, 2007 by the inventor named in the present Application. This Patent Application claims the benefit of the filing date of this cited Provisional Patent Application according to the statutes and rules governing provisional patent applications, particularly 35 U.S.C. §119(a)(i) and 37 C.F.R. §1.78(a)(4) and (a)(5). The specification and drawings of the Provisional Patent Application referenced above are specifically incorporated herein by reference as is set forth in their entirety.

### FIELD OF THE INVENTION

This invention generally relates to filters for purification of liquids. In particular, the present invention relates to an antimicrobial and/or bacteria static filter cartridge that can be used in a liquid filtration system for removal of particulates from the liquid being filtered, and to retard or prevent growth of bacteria therewithin.

### BACKGROUND OF THE INVENTION

U.S. Pat. No. 5,762,797 describes an Antimicrobial Filter cartridge that has a perforated core member wrapped with a micro porous membrane, which is then over-wrapped with a yarn that is treated with an antimicrobial agent. The perforated core of this filter cartridge is used as a support around which the micro porous membrane and the antimicrobially treated yarn are wound. These microporous membranes typically can be made of polysulfone, polyester, melt blown web of polypropylene or a trilaminate polypropylene membrane, and can be applied in at least one or more wrappings of the micro porous membrane about the core with the edges of the wrapping overlapping over each other to prevent by-passing of microorganisms. Such micro porous membranes, however, extremely fragile and are easily damaged during handling. Additionally, when the yam is subsequently wound around this microporous membrane, one has to be especially careful to ensure that the overlapping ends of the membrane are not disturbed. Besides the problem of fragility, these micro porous membranes also be very expensive.

U.S. Pat. No. 6,283,308 B1 further describes a bacteriostatic filter cartridge having a porous core member about which is layered a yarn and/or a polyester membrane, and/or a melt blown web of polypropylene, and/or a trilaminate polypropylene membrane, any or all of which may be impregnated with antimicrobial agent. The porous core member according to this Patent could either be activated carbon, plastic, paper, metal and/or ceramic.

The use of ceramic or activated carbon cores that have a pore size range of less than 1 micron, however, tends to create a problem of plugging of the pores. Use of ceramic cylinders of fine porosity where one end is closed and where the cavity of the ceramic tube is filled with granulated activated carbon further have been found to be prone to frequent pluggage due to bacterial growth and collected particulate matter. The microorganisms that are physically trapped on the ceramic surface often are not deactivated and can continue to grow unchecked, potentially producing harmful toxins into the water flow. Since the surface of the ceramic tube tends to accumulate the particulate (not having sufficient depth for the distribution of contaminants into the inner surfaces), the continued bacterial growth on the outer planar surface of the filter, makes plugging of the filter a recurrent issue. As a result, the surfaces of these ceramic filters generally have to be frequently scraped to remove such collected bacterial and particulate debris from their outer surfaces, in order to make these devices practicable.

More recently, microporous membranes have been developed that incorporate highly positively charged alumina or carbon nanofibers in a matrix of microglass fibers. Incorporation of these nanofibers with conventional fibers such as microglass or synthetic polypropylene or polyester fibers has been used to produce microporous membranes that also may have highly positive charges so as to be able to electrostatically retain negatively charged nanometer sized particles such as some bacteria, cysts and viruses on their surface. While microporous membranes containing nanofibers can be useful for filtering for bacteria, cysts and viruses, they generally are unable to deactivate these bacteria, cysts and viruses on their surfaces. As a result, when used in filtration applications, they tend to get plugged due to unchecked microbial growth reducing their service life.

Accordingly, it can therefore be seen that a need exists for an inexpensive and safe to use filtration cartridge for use in a liquid filtration system, which addresses the foregoing and other related and unrelated problems in the art.

### SUMMARY OF THE INVENTION

Briefly described, the present invention generally relates to an anti-microbial filter cartridge for use in liquid, primarily water, filtering applications. In one embodiment, the filter cartridge generally can include an inner microporous ceramic, activated carbon or plastic composite (possibly including an activated carbon material impregnated or otherwise included therein) core tube wrapped with a microporous membrane containing nanofibers to form a composite core. The core tube alternatively also can be formed from a microporous membrane containing nanofibers, paper or other cellulosic materials, metals, polymeric materials, or other synthetic materials and/or combinations thereof. The core tube also generally will include pores or flow openings of about 0.05 (or less) microns to about 5.0 (or more) microns and will define a central flow passage between the ends thereof. The core tube further generally is open on both ends and is surrounded by a sheath or outer wrapping, typically including tightly wound layers of criss-crossed yarn(s), or a fiberous mat of a non-woven material that is treated with an antimicrobial and/or bactericidal additive compound.

The yarn, non-woven, or other material applied about the core generally is wound or applied sufficiently tight so as to create a wrapping or sheath about the core defining very small openings through which the liquid being filtered can travel. These openings or pores help determine the size(s) of particulate matter that will be retained by the yarn or sheath material and thus trapped by the filter. The smaller the openings or pores desired, the tighter the winding of the yarn or non-woven sheath material around the core. Typically, pores within a range of approximately 0.05 microns to approximately 5 microns or greater, similar to the porosity of the core tube, can be used, although greater or lesser size pores also can be used for the outer wrapping or sheath of yarns/non-woven materials. Thus, the outer wrapping or sheath generally will capture the substantially larger particulate matter from the liquid flow passing therethrough, while the smaller particulates further are blocked or resisted from passing through the core tube by the pores of the inner core tube.

Various objects, features and advantages of the present invention will become apparent to those skilled in the art upon examination of the attached drawing, when taken in conjunction with accompanying detailed description.

### BRIEF DESCRIPTION OF THE DRAWINGS

FIG. 1 is a side elevational view of one embodiment of the antimicrobial filter cartridge of the present invention, with portions cut away.

FIG. 2 is a side elevational view of the filter cartridge of FIG. 1, with end-caps installed.

FIG. 3 is a schematic illustration of the filter cartridge of the present invention installed in a fluid flow or water delivery system.

FIG. 4 is a side elevational view of an additional embodiment, with portions cut away, of the antimicrobial filter cartridge according to the principles of the present invention.

FIG. 5 is a side elevational view of yet another embodiment, with portions cut away, of the antimicrobial filter cartridge of the present invention.

### DETAILED DESCRIPTION

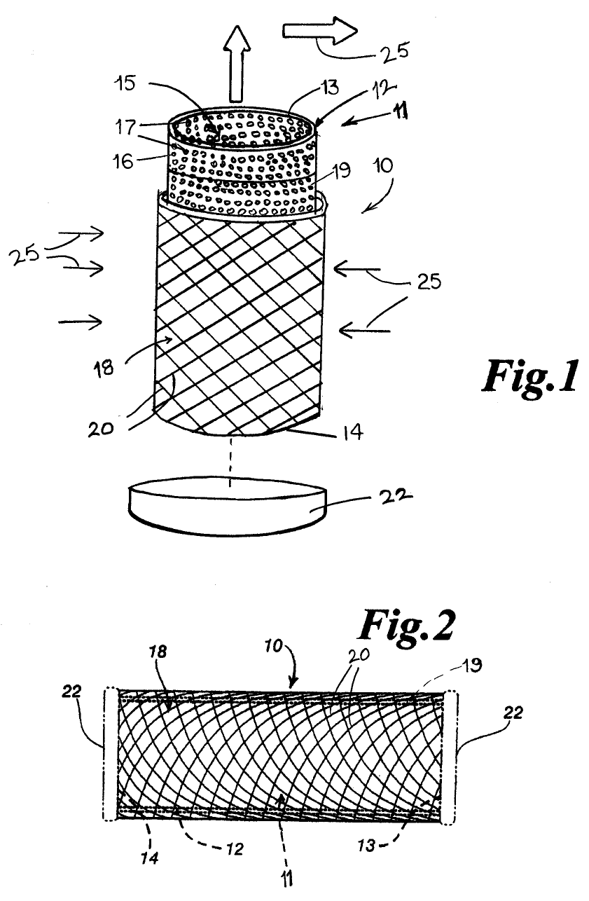

Referring now to the drawings in which like numerals indicate like parts throughout the several views, FIGS. 1-5 generally illustrate various embodiments of an antimicrobial and/or bacteriostatic filter cartridge 10 constructed in accordance with the principles of the present invention. The filter cartridge 10 generally will include a hollow, perforated or microporous core 11, including a core tube 12, which typically includes open-ends 13 and 14 and defines a flow passage 15 extending longitudinally therethrough. The core tube can be formed in varying configurations, including cylindrical, rectangular, etc., generally includes at least one perforated side wall 16 having a series of pores or perforations 17 formed therethrough.

In general, the antimicrobial and/or bacteriostatic filter cartridge formed according to the principles of present invention is designed for use in liquid filtration systems, and in particular for use in water filtration systems such as for drinking water and similar applications. In such applications, the filter cartridge generally is designed to reduce or substantially minimize the concentration of bacteria, cysts, viruses and other contaminants in the effluent water flow as compared to the concentration of such contaminants contained within the influent water flow. The primary function of the antimicrobial and/or bacteriostatic filter formed according to the principles of the present invention therefore is to safely, effectively and economically filter particulates, cysts, bacteria, viruses, and other contaminants from drinking water, while further inhabiting the growth of such bacteria viruses, cysts, and other microorganisms within the filter itself so as to prevent an increase in bacteria or viral count within the effluent flow coming from the filter.

In one example embodiment, the construction of the filter cartridge according to the principles of the present invention can consist of a composite core consisting of rigid, perforated or porous core tube 12 (FIG. 1) generally formed from a ceramic, plastic or activated carbon material, including having activated carbon layer(s) laminated together, or an activated carbon material impregnated in or applied along a plastic or polymeric substrate material to form the core tube. The core tube 12 further will be surrounded with one or more wrappings of a microporous membrane material 19 containing alumina or silver copper, zinc or carbon nanofibers, or mixtures thereof to form the composite core 11.

The core tube can be about 7″-9½″ long, and can be a round, cylindrical, or a substantially rectangularly shaped tube, although the core tube also can be of greater or lesser sizes and other varying configurations, depending on the filtration application. As shown in FIG. 1, the core tube, when consisting of either ceramic or activated carbon-containing materials (and/or including being covered with the microporous membrane 19), further generally will be formed with a series of pores or passages 17 through both the wall 16 of the core tube and the microporous membrane 17. The pores can be of a reduced size, typically in the range of approximately 0.05 microns to approximately 5.0 microns to control the porosity thereof and generally can have about a 1½″-2″ outer diameter, about a 1″-1½″ inner diameter and about a ⅛″-¼″ thick wall defining a central flow passages extending longitudinally therethrough.

Alternatively, in other embodiments, the core tube can be made of other materials such as a microporous membrane material containing nanofibers, metals, paper, or synthetic polymeric materials such as polypropylene, polyester, or other, similar materials. Such core tubes further may have much bigger openings that can be substantially square, rectangular, circular or other desired configurations, and can have diameters or lengths that generally are several millimeters (i.e., about 1 mm up to about 10 mm) long to facilitate easy flow. Onto such an open-ended, perforated polymeric core may be wound one or more wrappings of the microporous membrane material containing nanofibers 19, making it a composite core.

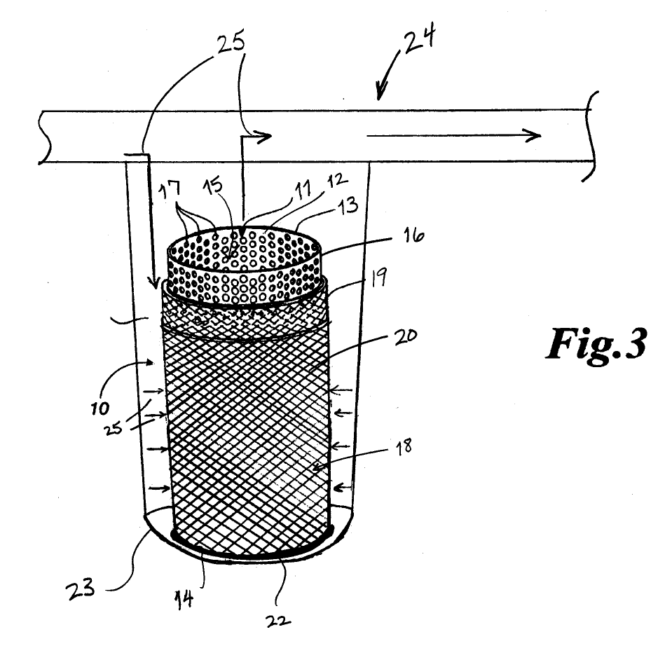

As shown in FIGS. 1-3, the core 11 further can be surrounded with a sheath or outer wrapping 18. The sheath 18 generally can comprise a tightly criss-crossed wound antimicrobially and/or bactericidally treated yarn 20, such as a polypropylene, nylon, cellulose acetate, rayon, lyocell, acrylic, polyester, and/or mixtures thereof. Alternatively, the sheath can comprise a fiberous, non-woven material. The spaced, open ends 13/14 of the core tube 12 also generally can be closed with end caps 22 (FIG. 2). The end caps can be formed from rubber, plastic,, or other, similar materials to allow the filter cartridge 10 to be used in a conventional filter cartridge housing 23 (FIG. 3), such as commonly used for water filtration systems 24. The end caps 22 further help provide containment and diversion of the water flow, indicated by arrows 25 in FIGS. 1 and 3, through the yarn wrapping sheath 18 and core tube 12.

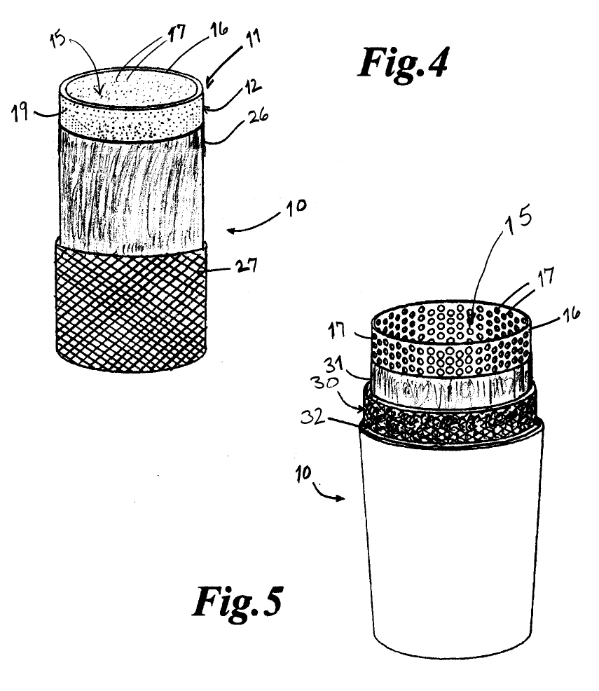

In an additional example embodiment shown in FIG. 4, the yarn wound about the composite core tube can be replaced by a non-woven antimicrobially and/or bactericidally treated fabric wrapping material 26 such as formed from polypropylene, nylon, acrylic, polyester, polyethylene, polylactic acid, polyvinyl chloride, polysulfone, polytrimethylemeterephthalate, and/or mixtures thereof. Still further, if needed or desired, the wrapping 26 also can be covered or surrounded with an outer wrapping or sheath of a criss-crossed yarn 27, which further can be treated with an antimicrobial and/or bactericidal material.

Alternatively, as indicated in FIG. 5, the yarn wound about the composite core tube also can be replaced with an antimicrobially treated porous covering 30 that can include an activated granular carbon material bonded or enclosed between layers 31/32 of a porous, non-woven substrate material, formed from polypropylene, nylon, acrylic, polyester, polyethylene, polylactic acid, polyvinyl chloride, Polyvinylalcohol polysulfone, polytrimethyleneterephthalate, and/or mixtures thereof. In another embodiment of the present invention, the composite core can include a rigid, perforated and/or highly open plastic tube about which one or more windings of microporous membrane containing, alumina or carbon nanofibers is applied, and further can be covered by an additional layer of criss-cross windings of an antimicrobially and/or bactericidally treated yarn and with endcaps on the two open ends.

By making the pores of the ceramic, plastic or activated carbon core tube of a size within a range of 0.05 to about 5.0 microns, the central core tube serves the functions of providing a support as well as acting as a rigid, micro-porous membrane. The composite core tube 12 (FIG. 1) discussed above, consisting of rigid, perforated, and/or highly open plastic tube surrounded by one or more wrappings of microporous membrane containing nanofibers typically can have a pore size of about 1 to 2-2.5 microns. It also will be understood, however, that pores of other, varying sizes also can be used. The yarn or non-woven wrapping or sheath further generally will be tightly applied about the core to define pores or flow passages therethrough, which pores typically can be larger, or approximately of similar size to the pores of the core tube (i.e., approximately 0.05-5 microns or larger), as needed for filtering out particulate matter and contaminants of varying sizes.

The wrapping of a tightly wound antimicrobial yarn about a composite core tube 12 further helps ensure that substantially all of the surface of the central core is protected from deposition of microbial debris and that no active microorganisms can proliferate on the surface of the micro-porous central core tube. Furthermore, subsequent layers of antimicrobially treated yarns wound about the core tube help ensure that most of the particulate matter, as well as some of the inactivated microorganisms, is distributed and trapped within the depth or layers of the filter provided by these multiple wrappings of the yarn. This ensures that the pores of the ceramic, plastic activated carbon, and/or composite (containing a substantially rigid, perforated plastic or synthetic material tube surrounded by a microporous membrane containing nanofibers) core will remain substantially free from obstructions or from otherwise becoming plugged by trapped particulates and/or microorganism matter, such as bacteria, cysts, viruses, etc. As a result, water can be filtered through the filter cartridge of the present invention for increased periods of use, while continuing to remove both microbial as well as particulate contaminants.

In addition to use of the antimicrobially treated yarns, the ceramic, plastic or activated carbon core tube or composite core can be treated with one or more non-leaching antimicrobial compounds to further help resist or inhibit growth of microorganisms, bacteria, cysts and/or viruses within the core tube itself, in the event such microorganisms are able to pass through the antimicrobially treated wrapping yarns. Examples of antimicrobial additives that can be used to treat the yarn and/or core tube generally can be selected from the group consisting of silver (elemental or nanoparticle silver with or without a substrate), zinc, (elemental or nanoparticle), copper (elemental or nanoparticle), zinc almandine, silver-zinc-zeolite, 2,4,4′-trichloro-2′-hydroxydiphenyl ether, diiodomethyl-4-tolylsulfone, zinc 2-mercaptopyridine-N-oxide, N-alkyl-N,N-dimethyl-N-benzylammonium chloride, sodium-O-phenylphenate, 1-5pentanedial (Glutarraldehyde, 2,2-dibromo-3-nitrilopropionamide, poly(hexamethylene biguanide), and cis 1-(3-chloroallyl)-357-triaza-1-azaniaadamantane.

It also is possible to add one or more antimicrobially treated fibers that are commercially available to the microporous membrane containing nanofibers during the manufacture of such a membrane. These antimicrobial fibers can elute sufficient quantities of antimicrobial agent that is safe for human ingestion but will still prevent the growth of bacteria, cysts and viruses and/or other microorganisms. Depending on the concentration of the antimicrobial ingredient in these fibers, it can be added to the microporous membrane during its manufacture in concentrations of about 0.05% to about 50% but preferably between about 1% to about 10% for optimum performance. Examples of such treated fibers available for use are silver treated polypropylene fibers from Agion Corp., AlphaSan (Milliken & Co.); silver coated nylom fibers called X-static (Noble Biomaterials), and Carolina Silver Technologies' silver coated polyester fiber. It is also possible to add quantities of nanosilver, nanocopper, and nanozinc fibers directly to the composite core microporous membrane material containing nanofibers during its manufacture in amounts of about 5 ppm to about 10,000 ppm, and preferably about 100 to about 1000 ppm.

In use, in a filtration system, as indicated in FIG. 3, the water or other liquid flows from outside the cartridge 10 through the yarn and the pores of the core tube, and into the central passage 15 of the core tube 12. The water flow thereafter is collected and directed through the central passage of the ceramic, activated carbon, or composite or plastic/synthetic core tube to an outside collection and/or delivery means. The present filter will be capable of long and sustained performance in removing bacteria, cysts, and viruses, as well as the particulate contamination from the water and will substantially prevent growth of microorganisms within the filter. Additionally, in conjunction with the activated carbon or activated carbon laminate core, this filter also can assist in the substantial removal chlorine taste and odor along with other dissolved total organic compounds (TOC) from the water or other liquid flow being filtered.

It will be further understood by those skilled in the art that while the present invention has been described above with reference to preferred embodiments, numerous variations, modifications, and additions can be made thereto without departing from the spirit and scope of the present invention as set forth in the following claims.

What is claimed is:

1. An antimicrobial filter cartridge, comprising:
a composite micro porous core including a ceramic, activated carbon or plastic core member and a microporous membrane containing nanofibers applied to said core member; and
a criss-crossed wound yarn applied to said core member and treated with antimicobial additive selected from the group comprising silver (elemental silver or nanoparticle silver); zinc; silver-zinc-zeolite; 2,4,4′-trichloro-2′-hydroxydiphenyl ether;diiodomethyl-4-tolylsulfone; zinc 2-mercaptopyridine-N-alkyl-N,N-dimethyl-N-benzylammonium chloride; sodium-O-phenylphenate; 1-5 pentanedial (Glutaraldehyde); 2,2-dibromo-3-nitrilopropionamide, poly(hexamethylene biguanide), and cis 1-(3-chloroallyl)-357-triaza-1-azoniaadamantane.

2. The antimicrobial filter cartridge of claim 1 and further comprising end caps applied to opposite ends of said core member to prevent by-pass of a fluid flow through said ends of said core member.

3. An antimicrobial filter cartridge comprising:
an inner micro porous core member having spaced, open ends and a series of pores of a defined porosity in the range of about 0.05 microns to about 5.0 microns between said ends;
a tightly criss-cross wound, antimicrobially treated yarn around said core member; and
end caps mounted at said ends of said core member to facilitate installation in a conventional housing and provide diversion and containment of unfiltered water through said yarn and said pores of said core tube.

4. The antimicrobial filter cartridge of claim 3, and wherein said antimicrobially-treated yarn further comprises an antimicrobial additive selected from the group comprising silver (elemental or nanoparticle silver with or without a substrate), zinc (elemental or nanoparticle), copper (elemental or nanoparticle), zinc almandine, silver-zinc-zeolite, 2,4,4′-trichloro-2′-hydroxydiphenyl ether, diiodomethyl-4-tolylsulfone, zinc 2-mercaptopyridine-N-oxide, N-alkyl-N,N-dimethyl-N-benzylammonium chloride, sodium-O-phenylphenate, 1-5pentanedial(Glutarraldehyde, 2,2-dibromo-3-nitrilopropionamide and cis 1-(3-chloroallyl)-357-triaza-1-azaniaadamantane.

5. The antimicrobial filter cartridge of claim 3 wherein said core member comprises a tubular member formed from activated carbon, ceramic, or a composite core comprising a perforated plastic tube surrounded with at least one wrapping of a microporous membrane including alumina or silver copper, zinc, carbon nanofibers, or mixtures thereof, polymeric materials, paper, metal, or combinations thereof.

6. The antimicrobial filter cartridge of claim 3, wherein said antimicrobially treated yarn comprises a yarn selected from the group consisting essentially of nylon, polypropylene, acrylic, polyester, polyethylene, polylacticacid, polyvinylchloride, microglass fibers, polyvinyl alcohol, polysulfone, polytrimethyleneterephthalate, and mixtures thereof.

7. The antimicrobial filter cartridge of claim 3 and wherein said core member further comprises an antimicrobial additive selected from the group comprising silver (elemental or nanoparticle silver with or without a substrate), zinc (elemental or nanoparticle), copper (elemental or nanoparticle), zinc almandine, silver-zinc-zeolite, 2,4,4′-trichloro-2′-hydroxydiphenyl ether, diiodomethyl-4-tolylsulfone, zinc 2-mercaptopyridine-N-oxide, N-alkyl-N,N-dimethyl-N-benzylammonium chloride, sodium-O-phenylphenate, 1-5pentanedial(Glutarraldehyde, 2,2-dibromo-3-nitrilopropionamide and cis 1-(3-chloroallyl)-357-triaza-1-azaniaadamantane.

8. An antimicrobial filter cartridge comprising an inner micro porous composite core member having at least one wall having a series of pores of a defined porosity in a range of about 0.05 to about 5.0 microns and spaced ends; a microporous membrane applied to said core member; an antimicrobially treated non-woven fabric tightly applied about said core member; and end caps mounted about said spaced ends of said core member to provide diversion and containment of unfiltered water through said fabric and said pores of said core member.

9. The antimicrobial filter cartridge of claim 8, and wherein said non-woven fabric further comprises an antimicrobial additive selected from the group comprising silver (elemental or nanoparticle silver with or without some substrate), zinc (elemental or nanoparticle), copper (elemental or nanoparticle), zinc almandine, silver-zinc-zeolite, 2,4,4′-trichloro-2′-hydroxydiphenyl ether, diiodomethyl-4-tolylsulfone, zinc 2-mercaptopyridine-N-oxide, N-alkyl-N,N-dimethyl-N-benzylammonium chloride, sodium-O-phenylphenate, 1-5pentanedial(Glutarraldehyde, 2,2-dibromo-3-nitrilopropionamide and cis 1-(3-chloroallyl)-357-triaza-1-azaniaadamantane.

10. The antimicrobial filter cartridge of claim 8 wherein said core member is selected from the group comprising activated carbon, ceramic, polymeric materials, paper, and metal.

11. The antimicrobial filter cartridge of claim 8 wherein said non-woven fabric wrap comprises at least one member selected from the group comprising nylon, polypropylene, acrylic, polyester, polyethylene, polylacticacid, polyvinylchloride, polyvinylalcohol, polysulfone, polytrimethyleneterephthalate, and mixtures thereof.

12. The antimicrobial filter cartridge of claim 10 and wherein said core member further comprises an antimicrobial additive selected from the group comprising silver (elemental or nanoparticle silver with or without a substrate), zinc (elemental or nanoparticle), copper (elemental or nanoparticle), zinc almandine, silver-zinc-zeolite, 2,4,4′-trichloro-2′-hydroxydiphenyl ether, diiodomethyl-4-tolylsulfone, zinc 2-mercaptopyridine-N-oxide, N-alkyl-N,N-dimethyl-N-benzylammonium chloride, sodium-O-phenylphenate, 1-5pentanedial(Glutarraldehyde, 2,2-dibromo-3-nitrilopropionamide and cis 1-(3-chloroallyl)-357-triaza-1-azaniaadamantane.

13. An antimicrobial filter cartridge comprising an inner microporous core member having a plurality of pores of about 0.05 to about 5.0 microns formed therethrough and spaced open ends; an antimicrobially-treated fabric comprising an activated granular carbon material bonded between layers of a non-woven substrate wound tightly around said core member; and, end caps applied to said ends of said core member.

14. The antimicrobial filter cartridge of claim 13, and wherein said carbon-composite non-woven fabric wrap further comprises an antimicrobial additive selected from the group consisting essentially of silver (elemental or nanoparticle silver with or without a substrate), zinc (elemental or nanoparticle), copper (elemental or nanoparticle), zinc almandine, silver-zinc-zeolite, 2,4,4′-trichloro-2′-hydroxydiphenyl ether, diiodomethyl-4-tolylsulfone, zinc 2-mercaptopyridine-N-oxide, N-alkyl-N,N-dimethyl-N-benzylammonium chloride, sodium-O-phenylphenate, 1-Spentanedial(Glutarraldehyde, 2,2-dibromo-3-nitrilopropionamide and cis 1-(3-chloroallyl)-357-triaza-1-azaniaadamantane.

15. The antimicrobial filter cartridge of claim 13 wherein said core member comprises activated carbon, ceramic, polymeric materials, paper, or metal.

16. The antimicrobial filter cartridge of claim 13 wherein said non-woven substrate comprises nylon, polypropylene, acrylic, polyester, polyethylene, polylacticacid, polyvinylchloride, polyvinylalcohol, polysulfone, polytrimethyleneterephthalate, and mixtures thereof.

17. The antimicrobial filter cartridge of claim 16 and wherein said core member further comprises an antimicrobial additive selected from the group comprising silver (elemental or nanoparticle silver with or without a substrate), zinc (elemental or nanoparticle), copper (elemental or nanoparticle), zinc almandine, silver-zinc-zeolite, 2,4,4′-trichloro-2′-hydroxydiphenyl ether, diiodomethyl-4-tolylsulfone, zinc 2-mercaptopyridine-N-oxide, N-alkyl-N,N-dimethyl-N-benzylammonium chloride, sodium-O-phenylphenate, 1-5pentanedial(Glutarraldehyde, 2,2-dibromo-3-nitrilopropionamide and cis 1-(3-chloroallyl)-357-triaza-1-azaniaadamantane.
